(19) United States
(12) Patent Application Publication
(10) Pub. No.: US 2022/0016850 A1
(43) Pub. Date: Jan. 20, 2022

(54) SYSTEM AND METHOD OF IMPLEMENTING ULTRASONIC SEALING IN PACKAGES

(71) Applicant: NORTHWEST BUBBLE INC., Beaverton, OR (US)

(72) Inventor: Wesley Jay Lawrence BURKE, Beaverton, OR (US)

(21) Appl. No.: 17/376,075

(22) Filed: Jul. 14, 2021

Related U.S. Application Data
(60) Provisional application No. 63/051,744, filed on Jul. 14, 2020.

(51) Int. Cl. B29C 65/08; B65B 51/22; B29C 65/00

(52) U.S. Cl. CPC B29C 65/08; B29C 66/723; B29C 66/851; B65B 51/225

(57) ABSTRACT

The present invention is an ultrasonic sealing method for sealing together multiple layers, of materials of different composite and may be dissimilar in nature the method comprising the steps of, a) feeding at least two work-pieces between an ultrasonic horn and an anvil, wherein said at least two work-pieces comprise a shipping envelope mailer with or without a cushion layer as a variable layered material b) sealing said two work-pieces, wherein said sealing comprises, (i) the outer layers may or may not be pre coated with a polymer and (ii) generating vibratory energy by a transducer and applying it to the horn which causes the horn to vibrate, wherein the frictional forces caused between the vibrating horn, and the anvil produces heat which is used to seal the two work-pieces together.

### FIELD OF INVENTION

The present invention relates to an apparatus and method for sealing edges in sealing packages and or shipping envelopes or mailers with or without a cushion layer. More particularly, the invention relates to ultrasonic sealing of packages.

### BACKGROUND

Conventionally, packages and or envelopes mailers with or without a cushion layer used for shipping are made with or without a plurality of inner layers comprising air bubble film layers that are machine-made. The steps of manufacturing, generally include but are not limited to 1) lamination, 2) folding, 3) edge sealing, 4) cooling, 5) cutting, and 6) stacking. The traditionally employed method for edge sealing is thermal-based sealing or heat sealing. Typically, in thermal sealing, no adhesive is applied to the package structure material. Instead, the package structure is sealed by passing the material between a heated pair of bars. The pair of bars are typically heated using thermal conduction. For example, an electric current may be passed through a heating element mounted to heat the bars. As the edges of the material are compressed between the heated pair of bars, the edges partially or fully melt and adhere to each other.

Thermal sealing suffers from a number of drawbacks. For example, thermal sealing of sensitive materials is typically a slow process. Thermal sealing is slow because the edges of the packaging material must be heated enough to melt to form a seal and are cooled later before cutting. Typically typical thermal sealing provides a continuous feed from potential lamination to indexing stacking finished goods. However, thermal sealing is ineffective for sealing composite or dissimilar materials or similar materials, particularly it is difficult to seal all layers of the material creating a product suitable for a courier or postal service when the outer skin layer is more or similarly sensitive to heat than the inner sealing layers. Thus, conventional sealing applications are often forced to choose between the integrity of the seal and the speed of formation of the seal.

### SUMMARY OF THE INVENTION

The present invention relates to an apparatus and method for sealing edges of the envelope mailer. More particularly, the invention relates to ultrasonic sealing of a shipping envelope mailer with or without a cushion layer.

According to an embodiment, the ultrasonic sealing device comprises an ultrasonic horn and an anvil and is configured to generate an ultrasonic energy in the form of high frequency. The generated energy is applied to the horn which causes the horn to vibrate. The frictional forces caused between the vibrating horn, acting as a first welding surface and the anvil, acting as a second welding surface, produce heat which is used to seal the two work-pieces together, wherein the work-pieces are placed in between the horn and the anvil.

According to an embodiment, the ultrasonic sealing device comprises a horn as an output tool that tunes the vibrations to a tip with the vibration of the transducer, applies force to the layers to be joined, and directs the energy to the area to be joined and is generally designed for sealing the edges of the structure. The horn comprises at least one plane coupled to the welding face of the horn.

According to another embodiment, the ultrasonic sealing device comprises a horn as an output tool that tunes the vibrations to a tip with the vibration of the transducer, applies force to the layers to be joined, and directs the energy to the area to be joined and is generally designed for sealing the edges of variable layers of shipping envelope mailer. The structure of the horn may be designed to incorporate a continuous plane, or one or more planes placed adjacent to each other, or one or more planes that are equidistantly placed extending along the welding surface of the horn. To seal the edges of the variable layered structure, the geometry of the horn of the ultrasonic sealing device is altered to affect the force felt by the work-piece in specified portions.

According to an embodiment, the present invention is an ultrasonic sealing method for sealing together multiple layers of an envelope mailer structure, the method comprising the steps of, a) feeding at least two work-pieces between an ultrasonic horn and an anvil, wherein said at least two work-pieces comprise an envelope mailer as a variable layered structure and b) sealing said two work-pieces, wherein said sealing comprises, (i) a bonded outer layer, and (ii) generating vibratory energy by a transducer is applied to the horn which causes the horn to vibrate, wherein the frictional forces caused between the vibrating horn, and the anvil produces heat which is used to seal the two work-pieces together.

According to an embodiment, the present invention is an ultrasonic sealing method for sealing together multiple layers of a variable layered structure, wherein the layers of the structure may be of similar or different compositions and are similar or dissimilar in composition and thickness. The portion of the structure having increased layers or thickness may be referred to as the increased portion. The portion of the structure having the standard number of layers may be referred to as the standard portion. The method comprising the steps of, a) feeding at least two work-pieces with increased and standard portions between an ultrasonic horn and an anvil, wherein said at least two work pieces comprise the structure as a variable layered material b) sealing the increased and standard portions to form a casing of bonded region, wherein the sealing comprises, (i) bonded outer layer material and (ii) generating vibratory energy and applying the energy to the horn which causes the horn to vibrate, wherein the frictional forces caused between the vibrating horn, and the anvil produces heat which is used to seal the increased and standard portions together.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 illustrates a from profile view of an ultrasonic sealing device comprising features in one embodiment.

FIGS. 2A, 2B and 2C illustrate the cross-sectional views of the horn 110 according to one or more aspects of the present invention.

FIGS. 3A, 3B and 3C are profile views of an anvil of the sealing device comprising seal cutting and design features in accordance with the present embodiment; and

FIGS. 4A, 4B and 4C are partial cross-sectional views of the edge regions of a package showing various potential constructions of the sealed areas in accordance with the present embodiment.

### DETAILED DESCRIPTION OF THE PREFERRED EMBODIMENT

Before describing the present invention in detail, it is to be understood that this invention is not limited to particularly exemplified method or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to “a blister” includes two or more such blisters.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In describing the present invention, the following terms will be employed, and are intended to be defined as indicated below.

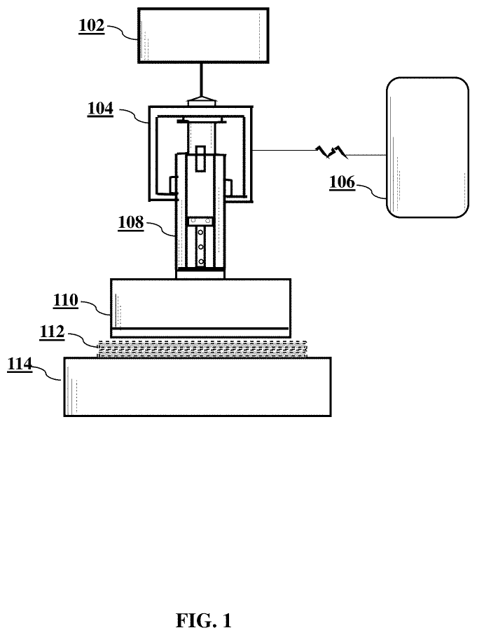

FIG. 1 illustrates a front profile view of the ultrasonic sealing device 100 according to an embodiment. The ultrasonic sealing device 100 comprises a pneumatic press 102, a transducer 104, an ultrasonic generator 106, a booster 108, a horn or a sonotrode 110 and an anvil or a base 114.

In one embodiment, the pneumatic press 102 is attached to a mounting plate or surface and includes a surface that acts as a force application region. By applying enough downward force to the force application region, the pneumatic press 102 generates compressive forces to the horn 110 at the nodal regions thereof, thereby permitting greater overall delivery of force to the associated work-pieces.

In one embodiment, the ultrasonic transducer 104 converts the electrical energy of the power supply into mechanical vibrations. FIG. 1 illustrates a single transducer but virtually any number of transducers may be utilized.

In one embodiment, the ultrasonic generator 106 is a commercial power line frequency source that is converted to high electrical frequencies of ultrasonic range or higher.

In one embodiment, the amplitude booster 108 amplifies the mechanical vibrations of the transducer 104.

In one embodiment, the horn 110 is an output tool that tunes the vibrations to a tip with the vibration of the transducer, applies force to the layers to be joined, and directs energy to the area to be joined and is generally designed for a sealing the edges of objects (such as a package 112). According to one embodiment, the horn 110 comprises of at least one plane placed along the welding face of the horn 110. The horn 110 maybe a bar of metal such as titanium, aluminum, steel, and combinations thereof which is dimensioned to be resonant at the desired frequency and the planes may be coupled to the welding surface of the horn 110.

According to some embodiments, the structure of the horn 110 may be designed to incorporate a continuous plane, or one or more planes placed adjacent to each other, or one or more planes that are equidistantly placed extending along the welding face of the horn 110. To seal the edges of the variable layer structure, the geometry of the horn 110 of the ultrasonic sealing device is altered to affect the force felt by the work-piece in specified portions.

The protrusion of the planes results in more force being applied to the increased portion. This provides sufficient energy to seal the materials at the increased portion. Simultaneously, the non-raised portion of the plates provides sufficient force to seal the materials at the standard portion.

In one embodiment, the anvil 114 is used to position and fix the layers to be joined so that the vibration energy directs to the desired area to be joined. The anvil 114 may be composed of any material. In one embodiment the anvil 114 is composed of the same material as the horn 110.

In one embodiment the anvil 114 is adjustable during the sealing process. The surface of the anvil 114 can be moved back and forth according to the energy dissipation to seal the work-pieces 112. The adjustable anvil 114 is an anvil that bends, adjusts or otherwise complies to provide equal force along the sealing area. An adjustable anvil 114 can be achieved in a variety of ways. For example, the anvil may comprise facets of removable material along the surface of the anvil 114. These facets allow the anvil 102 to comply under varying loads across the face of the anvil 102.

In another embodiment, the anvil 114 is stationary during the sealing process. With a rigid anvil 114, the anvil can experience pockets of increased localized force.

According to an embodiment, the transducer 104 generates ultrasonic energy in the form of high frequency, typically low amplitude mechanical vibrations through the pneumatic press 102, received from ultrasonic generator 106. In one embodiment the transducer 104 operates between 10 kHz and 70 kHz. The vibratory energy supplied by the transducer 104 is applied to the horn 110 which causes the horn 110 to vibrate. The frictional forces caused between the vibrating horn 110, acting as a first welding surface and the anvil 114, acting as a second welding surface, produces heat which is used to seal the two work-pieces 112 together.

Further, the mechanical pressure through the pneumatic press 102 is applied prior to and/or during and/or after the sealing of the work-pieces 112 to remove any interstitial air gaps between the work-pieces 112 and promote good thermal and acoustic contact. The pressure also helps to hold and help the work-pieces 112 fuse as they cool. The pressure can also be used to change the energy dissipated into a work-piece 112 by applying different pressures across the weld joint so that the contact resistance varies. According to another embodiment, the pressure can also be applied via servo motors, via hydraulic cylinders, or via any device known in the art to apply pressure.

According to an embodiment, the horn 110 and the anvil 114 are two welding surfaces on which the work-pieces 112 are sealed. Sealing refers to bonding at least two work-pieces together to create a seal. Any work-pieces which can be sealed can be utilized. In one embodiment, and as depicted in FIG. 1, the work-pieces 112 comprise in a layered structure using typical materials or composite dissimilar material. The work-pieces 112 can also be any work-piece that can be ultrasonically sealed or welded.

In one embodiment these structures are formed of plastics, such as polypropylene and polyethylene, but can also be metalized films, foil, paper, or oriented films. For example, the structure may consist of combination coated aluminum film, polyethylene terephthalate (PET) film, vinyl film, low-density PE (Polyethylene) films, linear low-density PE films, high-density PE films, polypropylene films, biodegradable films, hybrid biodegradable films, polypropylene non-woven material, polyester, non-woven materials, or cushion layers of polyethylene foam polypropylene foam starch foam rubber foam kraft layered tissue newsprint layered tissue rebounded fabric layered non woven material or any other type of material to form a cushion layer of the envelope mailer or any other dissimilar material combined in a composite format.

In one embodiment, the material may be any material used for the manufacturing or making of the layer(s) of the envelope mailer. In one embodiment, the composite structures used is recyclable reusable degradable and or biodegradable material in whole or in part.

Although FIG. 1 illustrates a first layer and a second layer, it should be understood that each layer can comprise multiple layers. For example, the first layer may comprise of two or more layers of material and the second layer may comprise of two or more layers. In one embodiment, the outer layer can be pre-coated with polyethylene or any other material that will bond to the outer layer prior to proceeding with the sealing step.

For sealing, the edges of the structure with multiple layers, the two or more layers are sealed by melting or softening the first bondable layer to the adjacent layer. The vibrations induced from the transducer 104 generate frictional heat which raises the local temperature of at least one layer above its melting or softening temperature such that the heat transfer bonds the adjacent layer.

In an exemplary scenario, the structure may comprise of a top layer that further comprises an inner or lap seal and a bottom layer with an inner or a lap seal. Further, while an inner seal is discussed this should not be deemed limiting. Any such seal or another scenario which results in a varied number of layers across a seal or increased thickness in the package structure can be utilized. In one embodiment the inner seal is previously sealed, whereas in other embodiments the inner seal comprises an overlap of layers.

In one embodiment, the layers of the structure may be of different compositions and are dissimilar in structure and thickness. In another embodiment, the layers of the structure are of the same composition. The inner seal with increased number of layers results in increased thickness. The portion of the structure having increased layers or thickness may be referred to as the increased portion. The portion of the structure having the standard number of layers may be referred to as the standard portion. A structure that comprises an increased portion and a standard portion is referred to as a variable layer structure. In some embodiments, the increased portion comprises three or more layers and the standard portion comprises two or more layers. In other embodiments, the increased portion comprises at least one additional layer compared to the standard portion. In other embodiments, the increased portion comprises the same number of layers as the standard portion but has an increased thickness compared to the standard portion. The thickness may result from a variety of reasons including an increased thickness of one of the layers.

The method of sealing the envelope mailer structure with the increased and the standard portions comprises the steps of, a) feeding at least two work-pieces with increased and standard portions between an ultrasonic horn and an anvil, wherein said at least two work pieces comprise a structure as variable layered b) sealing the increased and standard portions to form a casing of bonded region, wherein the sealing comprises, (i) the bonded outer layer material and (ii) generating vibratory energy and applying the energy to the horn which causes the horn to vibrate, wherein the frictional forces caused between the vibrating horn, and the anvil produces heat which is used to seal the increased and standard portions together.

Although, FIG. 1 shows a horn 110 comprising only a single continuous plane. It should be understood that in other embodiments the horn 110 comprises multiple planes.

According to an embodiment, during the sealing process, the anvil 114 remains stationary whereas the horn 110 is lowered. Thus, the horn 110 is vertically moveable relative to the anvil 114. In another embodiment, the horn 110 is stationary whereas the anvil 114 is moved during sealing. The downward pressure applied by the horn 110 and/or anvil 114 promotes sealing. After a specified time, the horn 110 is lifted. In one embodiment the desired seal time is as short as possible which allows for more throughput. The times vary according to pressure and gain, but times as low as about 0.01 s to 0.5 s seconds per seal time have been achieved.

In one embodiment, the horn 110 and/or the anvil 114 also comprises a cutting device such as a knife or blade which severs the film before, after, or during sealing. In one embodiment the horn 110 and/or the anvil 114 is knurled. The knurled design can also affect the gain as well as the localized contact force across a seal. Many of the same principles which were responsible for the varied gain across a non-uniform horn 110 also apply to a knurled design. The knurl height and spacing are used to impact the localized contact force.

Further, the ultrasonic sealing system 100 may comprise sensors to monitor the velocity of the film and other such processing variables. For example, if the velocity of the structure changes, other processing variables are adjusted to maintain the desired applied energy. For example, the amplitude of the horn 110 or the force applied to the horn 110 can be adjusted to maintain the desired energy application even in light of other processing changes. Any sensor and control system can be used to monitor the velocity and status of the structure such as a tachometer or an encoder or motor controllers.

A mechanical hard stop may also be used to prevent the hard contact between the horn 110 and the anvil 114. When the mechanical stop is engaged, the mechanical stop defines the closest distance between the horn and the anvil. In one embodiment this distance is preset according to the structure thickness. A mechanical stop thus prevents burn through which results from too much ultrasonic energy. The mechanical stop comprises any mechanical device which limits the distance between the horn 110 and the anvil 114.

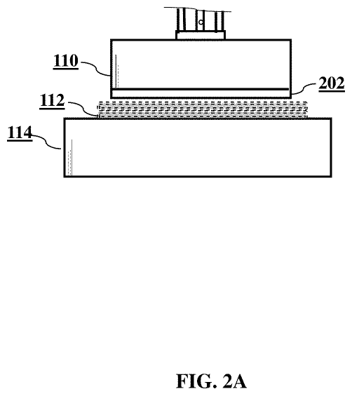

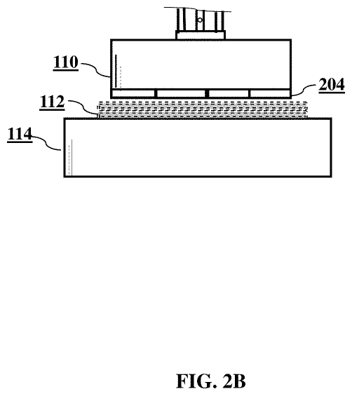

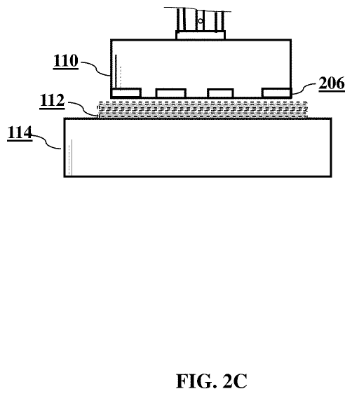

FIGS. 2A, 2B and 2C illustrate the cross-sectional views of the horn 110 according to one or more aspects of the present invention. The geometry of the horn 110 is altered to affect the force felt by the work-piece in specified portions as illustrated in FIGS. 2A-2C. As depicted in FIG. 2A, the horn tip of the horn 110 comprises a uniform length 202 and is configured as a continuous plane. The length of the horn 110 is measured along the surface facing towards the anvil 114. The horn 110 in FIG. 2A is configured to generate uniform amplitude of energy gain across the region and provide a uniform force to the work-pieces 112.

FIGS. 2B & 2C illustrate the geometry of the horn 110 of non-uniform length. In one embodiment, the horn tip of the horn 110 comprises one or more flat planes placed adjacently next to another, as shown in FIG. 2B. In another embodiment, the horn tip of the horn 110 comprises one or more flat planes equidistantly placed to provide controlled incremental sealing.

The geometry of horn in FIGS. 2B & 2C delivers a non-uniform amplitude and comprises planes which provide for the non-uniform amplitude. The structure or the gaps of the planes of the horn 110 create one or more slots in between the plates, wherein the slots alter the energy gain in the area between the slots. The region between the slots is also referred to as a slot portion. Comparatively speaking, different gains are experienced in the slots of the horn 110.

Furthermore, the shape, number, thickness, etc., of the plates 202, 204, 206 of the horn can be adjusted to obtain the desired energy gain. While in one embodiment, the plates 202 are utilized to result in non-uniform gain across the face of the horn 101, in other embodiments the plates 204, 206 are utilized to ensure there is an alteration in the gain of energy dissipated based on the thickness of the layers of the work pieces 112 to be sealed.

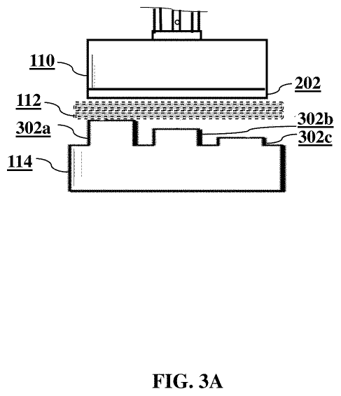

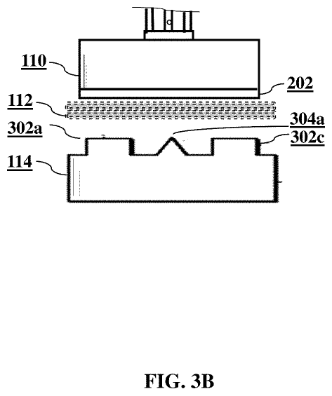

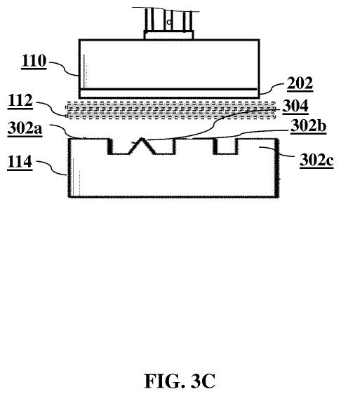

FIGS. 3A-3C illustrate side profile views of the anvil 114 of the sealing device 100 comprising seal cutting and design facets for enabling a multitude of surface welding patterns in accordance with the present embodiment.

FIG. 3A illustrates the anvil 114 seal pattern with adjusted heights and spacing of the facets 302a-302c that imprints a seal with varying incremental patterns. If the goal is to imprint a seal in a decremental pattern then the height and spacing of the facets 302a-302c is adjusted accordingly.

FIGS. 3B & 3C illustrate a side profile view of an anvil 114 comprising a cutting facet 304, the cutting facet concentrates the force, pressure, and accordingly, the energy at a point resulting in an over weld at the desired location, the material is cut at the location of the cutting facet 304. FIG. 3B shows the cutting feature 304 between two adjacent features 302a and 302b. FIG. 3C shows the cutting feature 304 between three adjacent features 302a-c. In this scenario, a single anvil 114 creates two seals for different packages. For example, in one embodiment, the left facet 302a seals the bottom seal of an upstream structure while the right feature 302c simultaneously seals the top seal of a downstream structure. While the seals are being made, simultaneously the upstream and downstream structures are severed with the cutting facet 304. This provides for the elimination of separate cutting equipment such as a knife. Further, this allows the sealing and cutting to take place simultaneously and with the same equipment.

The height and geometry of the cutting facet 304 may vary. In one embodiment, the cutting facet 304 is in the same vertical plane as the adjacent facets 302a-c, meaning they are of equal height, but its geometry is that of a point that concentrates force and pressure resulting in a cut. In other embodiments, the cutting facet 304 has a greater height than non-cutting facets. In one such embodiment, the horn 110 comprises a recessed portion that can receive the elevated cutting facet 304.

The facets 302a-c, 304 enable sealing and cutting, the facets may be adjusted to provide a variety of benefits. For example, while the facets may result in a line seal, in other examples, a different shape of seals are obtained. For example, rather than a line, the seal is in the shape of a logo or other geometric shapes such as a letter, number, or symbol. The seal can be wavy, circular, state a message, etc. The shape, height, and orientation of the facets 302a-c, 304 can be adjusted to obtain the desired seal shape.

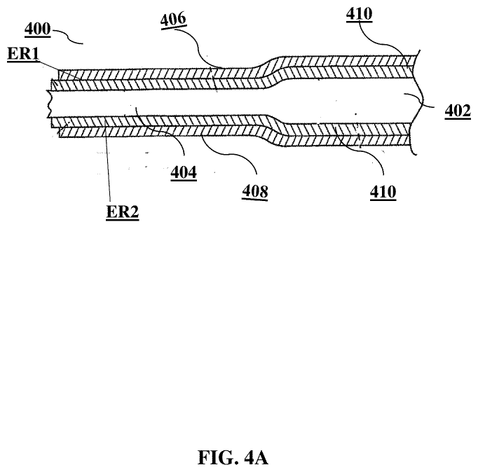

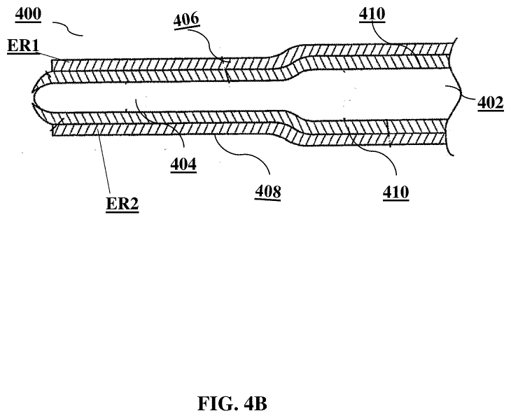

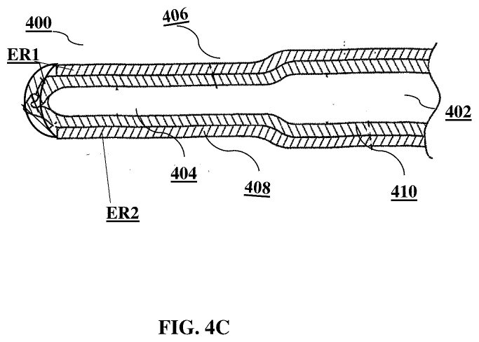

FIGS. 4A, 4B and 4C are partial cross-sectional views of the edge regions of a package 400 showing various potential constructions of the sealed areas using the ultrasonic sealing device 100. The package 400 includes a variable layer structures, where the surrounding mating surface forms a primary layer 406 and secondary layer 408 having fused regions and non-fused regions with edge regions ER1, ER2. In one embodiment, the primary and secondary layers may also include inner layers 410. In the exemplary scenario, the primary layer 406 and secondary layer 408 are bonded prior to proceeding with the sealing step. The seal is formed between the mating surfaces of the edge regions ER1, ER2 of the primary 406 and secondary layer 408 by transmitting heat to the inner core of the seal through the primary layer which is more resilient to heat than the inner layer 410.

The transducer 104 of the ultrasonic sealing device 100 generates ultrasonic energy in the form of high frequency, typically low amplitude mechanical vibrations through the pneumatic press 102, received from ultrasonic generator 106. The vibratory energy supplied by the transducer 104 is applied to the horn 110 which causes the horn 110 to vibrate. The frictional forces caused between the vibrating horn 110, acting as a first welding surface and the anvil 114, acting as a second welding surface, produce heat which is used to seal the primary 406 and secondary 408 layers together.

The seal advantageously provides a barrier to moisture entry. Sealing in the region of the trimming, or adjacent thereto, lessens the likelihood that leaks exist in the sealed region, and thus reduce leakage due to trimming. Transmitting energy as per the thickness of the layers close gaps in the non-fused regions of the primary seal, thus reducing the number of possible avenues of entry into the content of the package.

According to an embodiment, FIG. 4A illustrates the initial surface edges position before the sealing process, where the fused region 402 has a greater thickness between the primary and the secondary layers, while the non-fused region 404 has a lesser thickness.

When initial energy is dissipated in the specified regions through the ultrasonic sealing device 100 then the distance between the primary 406 and secondary 408 layers is tapered closer to each other thus tapering the thickness of the bonding layer, as depicted in FIG. 4B.

Following this, single or multiple rounds of heating may be potentially conducted a number of times until the edges regions ER1, ER2 of primary 406 and secondary 408 layers are coupled, such that bonded region forms a casing over the inner layer 410, thereby providing a more impermeable barrier. The seal formed may be continuous, or discontinuous. The seal, in a discontinuous configuration, may form a grid-like pattern or maybe otherwise interspersed with regions of non-fused base and lid material.

In one embodiment, the structure of the primary and secondary layers is supplied to the ultrasonic sealing device from a sheet feeder.

As will be appreciated by one having ordinary skill in the art, the above described ultrasonic sealing system and method provides an effective and efficient means for the manufacture of shipping envelopes mailers of laminate assemblies (with or without a cushion layer) having sealed regions that enhance the seal integrity of the shipping envelope mailer.

In addition the invention provides a significant advantage in the production of shipping envelopes mailers with or without a cushion inner layer allowing for the next generation of cushion envelopes mailers.

Additionally taking in account current global environmental initiatives with regards to more energy efficient manufacturing processes utilizing more efficient ultrasonic seam edge welding. Further additionally the construction of a shipping envelope mailer having composite layers that can be recyclable reused and biodegradable materials are key components to the invention.

1. An ultrasonic sealing system for sealing together multiple layers of a shipping mailer envelope with or without a cushion layer comprising:
a pneumatic or mechanically actuated press;
a transducer;
an ultrasonic generator;
a booster;
a horn having a first welding surface;
an anvil having a second welding surface;
wherein the horn comprises of at least one continuous plane or one or more planes placed adjacent to each other, or one or more planes that are equidistantly placed extending along the welding surface of the horn.

2. The system of claim 1, wherein the first welding surface and second welding surface are configured to receive at least one work-piece therein the part to be sealed along a section of the part.

3. The system of claim 1, operates between 10 kHz and 70 kHz.

4. The system of claim 1, wherein the shipping envelope mailer is a variable layered structure comprising an increased portion and a standard portion.

5. The system of claim 1, wherein the anvil is an adjustable anvil or a stationary anvil.

6. The system of claim 1, wherein the structure of the planes of the horn include one or more slots in between the plates, wherein the slots alter the energy gain in the area between the slots.

7. The system of claim 1, wherein the shape, number, thickness, the plates of the horn can be adjusted to obtain the desired energy gain.

8. The system of claim 1, wherein the frictional forces caused between the vibrating horn and the anvil produce heat which is used to seal the work-pieces together.

9. The system of claim 1, wherein the structure comprises layers of different compositions.

10. The system of claim 1, wherein the horn is vertically moveable relative to the anvil.

11. An ultrasonic sealing method for sealing together multiple layers of the structures of a shipping mailer envelope method comprising the steps of:
a. feeding at least two work pieces between an ultrasonic horn and an anvil, wherein said at least two work-pieces comprise a shipping envelope mailer with or without a cushioning layer;
b. sealing said two work-pieces, wherein said sealing comprises:
i. bonded outer layer; and
ii. generating vibratory energy by a transducer and applying it to the horn which causes the horn to vibrate, wherein the frictional forces caused between the vibrating horn, and the anvil produce heat which is used to seal the two work-pieces together.

12. The method of claim 11, wherein the horn acts as a first welding surface and the anvil acts as a second welding surface.

13. The method of claim 11, operates between 10 kHz and 70 kHz.

14. The method of claim 11, wherein the structure is a variable layered film comprising an increased portion and a standard portion.

15. The method of claim 11, wherein the anvil is an adjustable anvil or a stationary anvil.

16. The method of claim 11, wherein the horn comprises of at least one continuous plane or one or more planes placed adjacent to each other, or one or more planes that are equidistantly placed extending along the welding surface of the horn.

17. The method of claim 11, wherein the structure of the planes of the horn include one or more slots in between the plates, wherein the slots alter the energy gain in the area between the slots.

18. The method of claim 11, wherein the shape, number, thickness, the plates of the horn can be adjusted to obtain the desired energy gain.

19. The method of claim 11, comprises a booster, a pneumatic press, a transducer, and an ultrasonic generator.

20. The method of claim 11, wherein the shipping envelope mailer comprises layers of different compositions and are dissimilar in structure and thickness.

21. The method of claim 11, comprises plurality composite structures made of recyclable reusable degradable or biodegradable material in whole or in part.
